(19) United States
(12) Patent Application Publication
(10) Pub. No.: US 2015/0372302 A1
(43) Pub. Date: Dec. 24, 2015

(54) HIGH ENERGY CATHODE MATERIALS AND METHODS OF MAKING AND USE

(71) Applicant: Wildcat Discovery Technologies, Inc., San Diego, CA (US)

(72) Inventors: Bin Li, San Diego, CA (US); Jen-Hsien Yang, San Diego, CA (US); Wei Tong, Albany, CA (US)

(73) Assignees: Wildcat Discovery Technologies, Inc., San Diego, CA (US); Tianjin B&M Science and Technology Joint-Stock Co., Ltd., Tianjin (CN)

(21) Appl. No.: 14/308,693

(22) Filed: Jun. 18, 2014

(51) Int. Cl. H01M 4/58

(52) U.S. Cl. CPC H01M 4/5825; H01M 2004/028

(57) ABSTRACT

A material for forming an electrode. The material is a lithium phosphate with a stoichiometric excess of lithium and dopants, such as alkaline earth metal or transition metal dopants, in lithium sites and other sites.

### BACKGROUND OF THE INVENTION

The present invention is in the field of battery technology and, more particularly, in the area of improved active materials for use in electrodes in electrochemical cells.

Olivine-type LiFePO₄ is one of the most promising cathode materials for large-scale lithium batteries because of its low-cost, non-toxicity, and extremely high stability. But, this cathode material has certain shortcomings, including comparatively poor conductivity and a comparatively low theoretical specific energy (about 530 Wh/kg) due to the comparatively low operating voltage of about 3.4 V.

Isostructural LiMnPO₄ is another interesting candidate for a new cathode material, in part because its comparatively flat 4.0V plateau versus Li/Li+ is compatible with commercial 4V class cathodes such as layered LiCoO₂ and spinel LiMn₂O₄. Further, the theoretical energy density is 684 Wh/kg, (derived as 171 mAh/g multiplied by 4.0 V), and this theoretical energy density is 1.2 times larger than that of LiFePO₄ (derived as 170 mAh/g multiplied by 3.4 V). Further, the isostructural LiMnPO₄ is compatible with the use of well-known electrolyte components, such as propylene carbonate (PC), ethylene carbonate (EC), and dimethoxyethane (DME).

However, as compared to other promising cathode materials LiMnPO₄ has demonstrated much lower reversible capacities than desired. Several hypotheses have been proposed in the literature to explain such poor performances, including: (i) lower intrinsic electronic conductivity, (ii) local lattice distortion around Jahn-Teller-active Mn³⁺ ions, and (iii) larger mechanical strains being developed at the boundary between Li-rich (lithiated) and Li-poor (delithiated) phases. Further, it has been reported that the electrical conductivity of LiMnPO₄ was measured to be lower by about five orders of magnitude than that of LiFePO₄. Thus, there remains a need to improve the performance of olivine-type cathodes. Certain research has been done into doping in LiMnPO₄, including U.S. Pat. No. 7,060,238; U.S. Patent Publication No. 2013/0140496; and European Patent No. 2178137. As described in further detail below, none of this research provides for improvements to olivine-type cathodes in the manner described herein.

### BRIEF SUMMARY OF THE INVENTION

According to some embodiments of the invention, a composition and method for making an electrode includes a material represented by Li₁₊ₓM1_{y}Mn_{z}PO₄ where 0.01≦x≦0.2, 0.01≦y≦0.1, and 0.95≦z≦1; and where M1 is a dopant. M1 can include an alkaline earth metal, such as Mg. In some embodiments, the electrode includes Li_{1.02}Mg_{0.03}MnPO₄. According to some embodiments of the invention, a composition and method for making an electrode includes a material represented by Li_{1.05-x}M1ₓMnPO₄ where 0.01≦x≦0.04 and M1 comprises an alkaline earth metal.

According to some embodiments of the invention, a composition and method for making an electrode includes a material represented by Li₁₊ₓMg_{y}Mn_{z}M1ₓPO₄ where 0.01≦x≦0.2, 0≦y≦0.1, 0.85≦z≦1, and 0.01 w 0.2; and M1 is one or more dopants. M1 can include a transition metal. M1 can include Fe, Co, Zn, Mg, V, Ni, Nb, Cu, Cr, Ti or a combination thereof. M1 can include three different elements selected from the group consisting of Fe, Co, Zn, Mg, V, Ni, Nb, Cu, Cr, and Ti. M1 can include Fe and two elements selected from the group consisting of Mg, Co, and Zn.

According to some embodiments of the invention, a composition and method for making an electrode includes a material represented by Li_{1.05-x}MgₓMn_{0.9-y-z}M1_{y}M2_{z}Fe_{0.1}PO₄ where 0.0051≦x≦0.04, 0≦y≦0.05, and 0≦z≦0.05; and M1 and M2 each comprise a transition metal or alkaline earth metal. M1 and M2 can each comprise a different transition metal or alkaline earth metal.

### BRIEF DESCRIPTION OF SEVERAL VIEWS OF THE DRAWINGS

FIG. 1 illustrates the effect of doping the Li site on capacity when samples are cycled between 4.5 V and 2 V for certain embodiments of the invention.

FIG. 2 illustrates the effect of doping the Li site on discharge energy when samples are cycled between 4.5 V and 2 V for certain embodiments of the invention.

FIG. 3 illustrates the effect of doping the Li site on charge capacity during constant current step when samples are cycled between 4.5 V and 2. V for certain embodiments of the invention.

FIG. 4 illustrates the effect of doping the Li site on discharge capacity percentage at 1 C of 0.1 C when samples are cycled between 4.5 V and 3 V for certain embodiments of the invention.

FIG. 5 illustrates traces of voltage versus capacity on the first cycle for a control LMP material (undoped) and certain materials from FIGS. 1 through 4 that consistently showed improved performance.

FIG. 6 illustrates significant first cycle capacity improvement for certain embodiments of the invention over undoped and singly doped materials.

FIG. 7 illustrates significant constant current charge rate capability improvement for certain embodiments of the invention over undoped and singly doped materials.

FIG. 8 illustrates significant discharge rate improvement for certain embodiments of the invention over undoped and singly doped materials.

### DETAILED DESCRIPTION OF THE INVENTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “about” refers to the range of values approximately near the given value in order to account for typical tolerance levels, measurement precision, or other variability of the embodiments described herein.

The term “transition metal” refers to a chemical element in groups 3 through 12 of the periodic table, including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), and meitnerium (Mt).

The term “lanthanide” refers to any of the fifteen metallic chemical elements with atomic numbers 57 through 71, including lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

The term “alkali metal” refers to any of the chemical elements in group 1 of the periodic table, including lithium (Li), sodium (Na), potassium (K), rubidium (Rb), cesium (Cs), and francium (Fr).

The term “alkaline earth metals” refers to any of the chemical elements in group 2 of the periodic table, including beryllium (Be), magnesium (Mg), calcium (Ca), strontium (Sr), barium (Ba), and radium (Ra).

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

To the extent certain battery characteristics can vary with temperature, such characteristics are specified at room temperature (about 30 degrees C.), unless the context clearly dictates otherwise.

Ranges presented herein are inclusive of their endpoints. Thus, for example, the range 1 to 3 includes the values 1 and 3 as well as intermediate values.

The terms “milling” and “mixing” are used interchangeably, except in the instances where low energy mixing processes are specified. In such instances, the materials were predominantly mixed rather than milled.

Embodiments described herein provide improved electrochemical performance for certain olivine-type cathode materials. In particular, the performance of isostructural LiMnPO₄ is improved via doping the material with selected transition metals. The improved LiMnPO₄ material includes an excess amount of lithium in addition to the dopants. That is, the amount of Li is non-stoichiometric as compared to conventional LiMnPO₄. Notably, it is the combination of excess lithium and multiple dopants that provide the improvements. The dopants are present in the Li site and on the Mn site.

According to certain embodiments, the performance of LiMnPO₄ is improved by synthesizing materials according to the formula:

Li₁₊ₓM1_{y}Mn_{z}PO₄ (i)

where 0.01≦x≦0.2, 0.01≦y≦0.1, and 0.95≦z≦1. In these embodiments, excess lithium is present and some of the Li sites are doped with M1. M1 can be a transition metal, a lanthanide, an alkali metal, or an alkaline earth metal. In a preferred embodiment, M1 is an alkaline earth metal. In a still further preferred embodiment, M1 is Mg. Particularly useful compositions include those in which M1 is present such that y=0.03. Among the preferred embodiments are the following compositions:
Li_{1.04}Mg_{0.01}MnPO₄,
Li_{1.03}Mg_{0.02}MnPO₄,
Li_{1.02}Mg_{0.03}MnPO₄, and
Li_{1.01}Mg_{0.04}MnPO₄.

As discussed further herein, preferred embodiments include an excess of lithium and such embodiments demonstrate significant improvement over cathodes formed from conventional LiMnPO₄ active materials.

According to certain embodiments, the performance of the compositions of Formula (i) above are further improved by synthesizing materials according to the formula:

Li₁₊ₓMg_{y}Mn_{z}M1_{w}PO₄ (ii)

where 0.01≦x≦0.2, 0≦y≦0.1, 0.85≦z≦1, and 0.01≦w≦0.2. In these embodiments, the LiMnPO₄ active material includes an excess of lithium and Mg is doped in the Li site. M1 is one or more dopants in the Mn site, and M1 can be a transition metal, a lanthanide, an alkali metal, or an alkaline earth metal. In a preferred embodiment, M1 is a transition metal. In a preferred embodiment, M1 is an alkaline earth metal. In still further preferred embodiments, M1 is Fe, Co, Zn, Mg, V, Ni, Nb, Cu, Cr, Ti or a combination thereof. Notably, these double doped compounds can provide performance improvements over the single doped compounds.

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### Examples

Materials and Synthetic Methods.

Stoichiometric ratios of LiH₂PO₄, MnCO₃, Fe(C₂O₄)₂H₂O, Li₂CO₃, Carbon KJ600, and TiO₂ were combined in reaction vessels along with 19 g of 5 mm diameter chrome steel ball bearings. Li₂CO₃ was added to provide excess Li compared stoichiometric LiMPO₄. A milling solvent such as hexane is optional. The wells were sealed, removed from glove box, and then milled with high energy milling. The milled precursors were heated to the 530 degrees C. at a rate of 5 degrees per minute for 3 hours under flowing nitrogen gas. Then, the vessels were cooled to room temperature at a rate of 5 degrees per minute. 5 wt % carbon was added based on final product mass, and the active material mass used to calculate specific capacity includes the carbon amount.

Electrode Formulation.

Cathodes based on the activated phosphate material were prepared using a formulation composition of 93:5:2 (active material:binder:conductive additive) according to the following formulation method. 94.3 mg PVDF (Sigma Aldrich) was dissolved in 12.5 mL NMP (Sigma Aldrich) overnight. 37.7 mg of conductive additive was added to the solution and allowed to stir for several hours. 40 mg of the activated phosphate material was then added to 1 mL of this solution and stirred overnight. Films were cast by dropping about 50 mL of slurry onto stainless steel current collectors and drying at 150 degrees C. for about 1 hour. Dried films were allowed to cool, and were then pressed at 1 ton/cm². Electrodes were further dried at 150 degrees C. under vacuum for 12 hours before being brought into a glove box for battery assembly.

Electrochemical Characterization.

All batteries were assembled in a high purity argon filled glove box (M-Braun, O₂ and humidity contents <0.1 ppm), unless otherwise specified. Cells were made using lithium as an anode, Celgard 2400 separator, and 90 mL of 1M LiPF₆ in 1:2 EC: EMC electrolyte. Electrodes and cells were electrochemically characterized at 30 degrees C. with a constant current C/10 charge rate followed by constant voltage step till the current reaches C/100 and discharge rate C/10 between 4.3 or 4.5 V and 2.0 V for the first two cycles. Starting from cycle 4, both charge and discharge rate is 1 C with slow rate C/10 on every 25^{th} cycle between 4.5 and 2 V.

### RESULTS

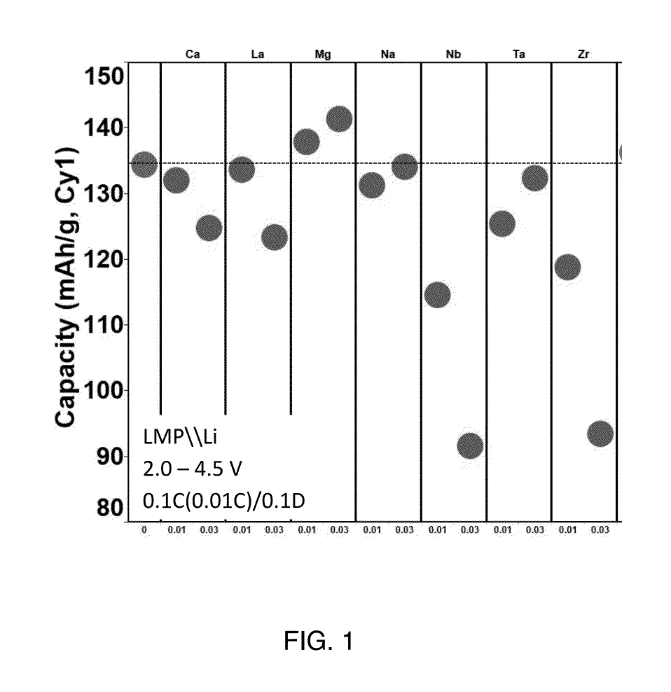

FIGS. 1, 2, 3, and 4 illustrate electrochemical characterization of embodiments in which different elements are doped into the Li site of an LMP active material. The materials in these figures can be represented by the formula:

Li_{1.05-x}M1ₓMnPO₄ (iii)

where for the control material, x=0, and for the doped materials, x=0.01 or 0.03. The identity of the dopant appears on the top x-axis and the concentration of the dopant appears on the bottom axis. For FIGS. 1, 2, 3, and 4, the dopants for the Li site were, in turn, Ca, La, Mg, Na, Nb, Ta, and Zr.

FIG. 1 illustrates the effect of doping the Li site on capacity when samples are cycled between 4.5 V and 2 V. The control material (undoped) shows a capacity of about 134 mAh/g. Improvement over control is seen for Mg doping on Li site. When x=0.03 for Mg, the capacity of that doped material is greater than about 140 mAh/g. Even the lower doping amount of x=0.01 for Mg on the Li site shows improvement as compared to the control material (undoped). Thus, in this example the most improved composition was Li_{1.02}Mg_{0.03}MnPO₄.

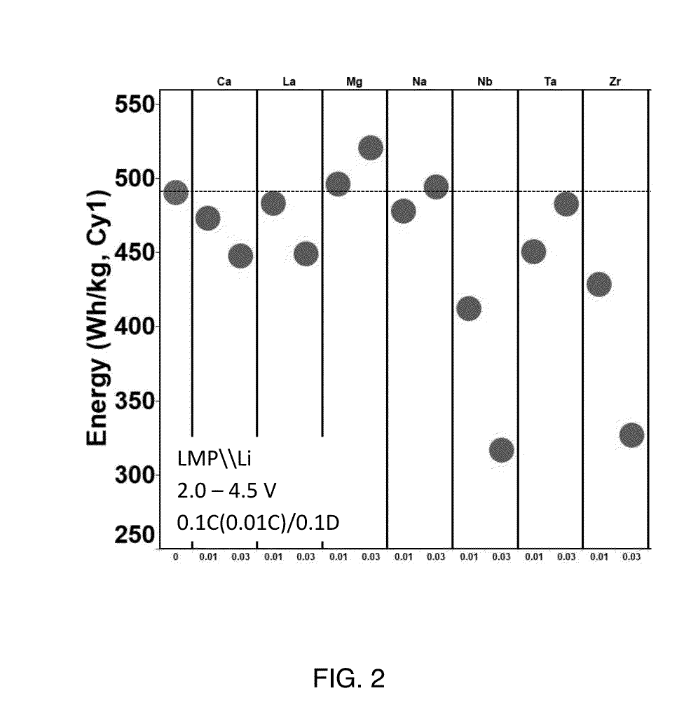

FIG. 2 illustrates the effect of doping the Li site on discharge energy when samples are cycled between 4.5 V and 2 V. The control material (undoped) shows a discharge energy of about 490 Wh/kg. Improvement over control is seen for Mg doping on Li site. When x=0.03 for Mg, the energy of that doped material is at least about 525 Wh/kg. Even the lower doping amount of x=0.01 for Mg on the Li site shows improvement as compared to the control material (undoped). Thus, in this example the most improved composition was Li_{1.02}Mg_{0.03}MnPO₄.

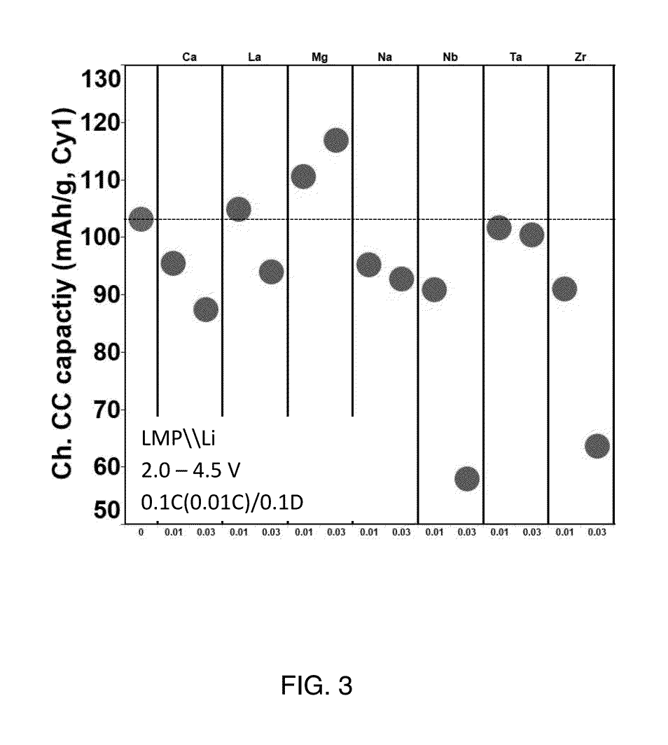

FIG. 3 illustrates the effect of doping the Li site on charge capacity when samples are cycled between 4.5 V and 2 V. The control material (undoped) shows a constant current charge capacity of about 104 mAh/g. Improvement over control is seen for Mg doping on Li site. When x=0.03 for Mg, the capacity of that doped material is about 120 mAh/g. Even the lower doping amount of x=0.01 for Mg on the Li site shows improvement as compared to the control material (undoped). Thus, in this example the most improved composition was Li_{1.02}Mg_{0.03}MnPO₄.

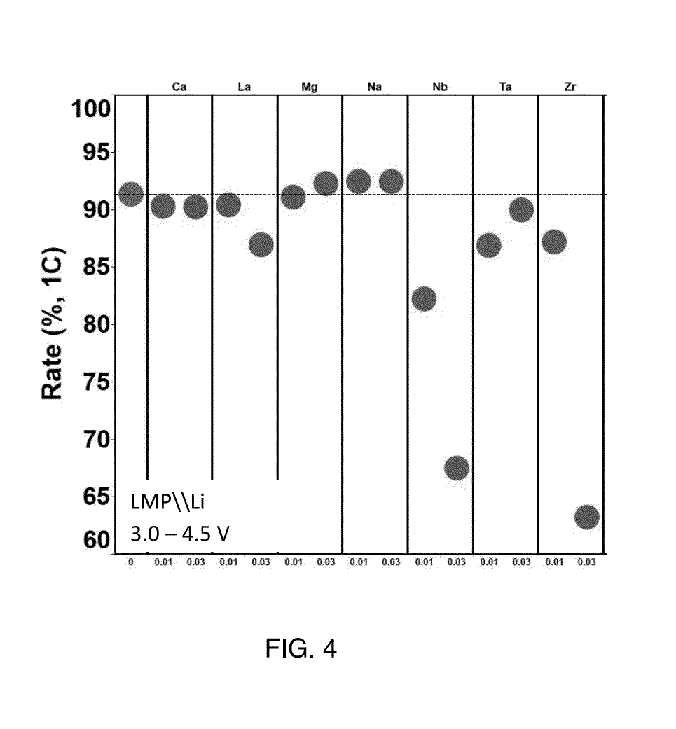

FIG. 4 illustrates the effect of doping the Li site on discharge rate capability when samples are cycled between 4.5 V and 3 V. The control material (undoped) shows a 1 C discharge capability of about 90.1% of C/10. A slight improvement over control is seen for Mg doping on Li site for x=0.03. The lower doping amount of x=0.01 for Mg on the Li site shows negligible improvement as compared to the control material (undoped). Thus, in this example Li_{1.02}Mg_{0.03}MnPO₄ showed some improvement over control.

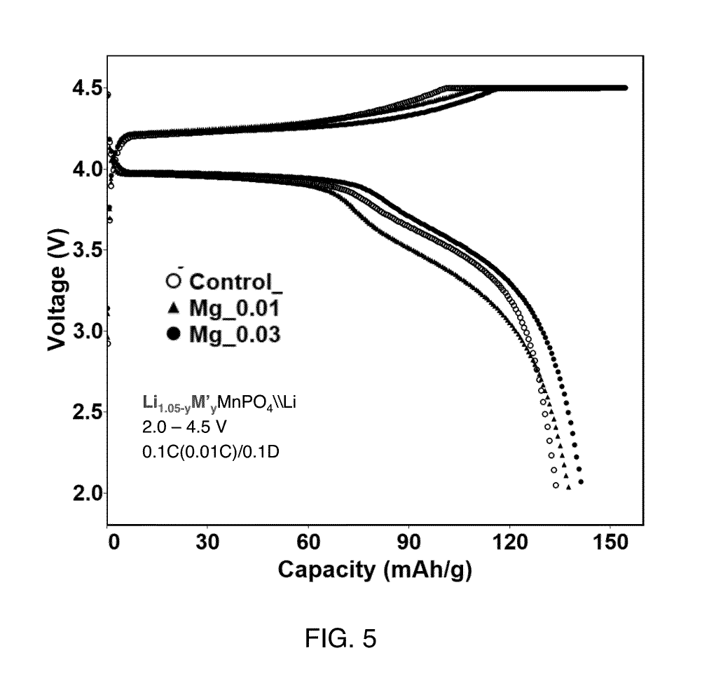

FIG. 5 illustrates traces of voltage versus capacity on the first cycle for a control LMP material (undoped) and the materials from FIGS. 1 through 4 that consistently showed improved performance (Li_{1.04}Mg_{0.01}MnPO₄ and Li_{1.02}Mg_{0.03}MnPO₄). FIG. 5 shows that Mg doping on the Li site significantly extends the discharge plateau. The Mg doping on the Li site also significantly improves hysteresis, as both the charge plateau and discharge plateau are improved. Again, in this example the most improved composition was Li_{1.02}Mg_{0.03}MnPO₄.

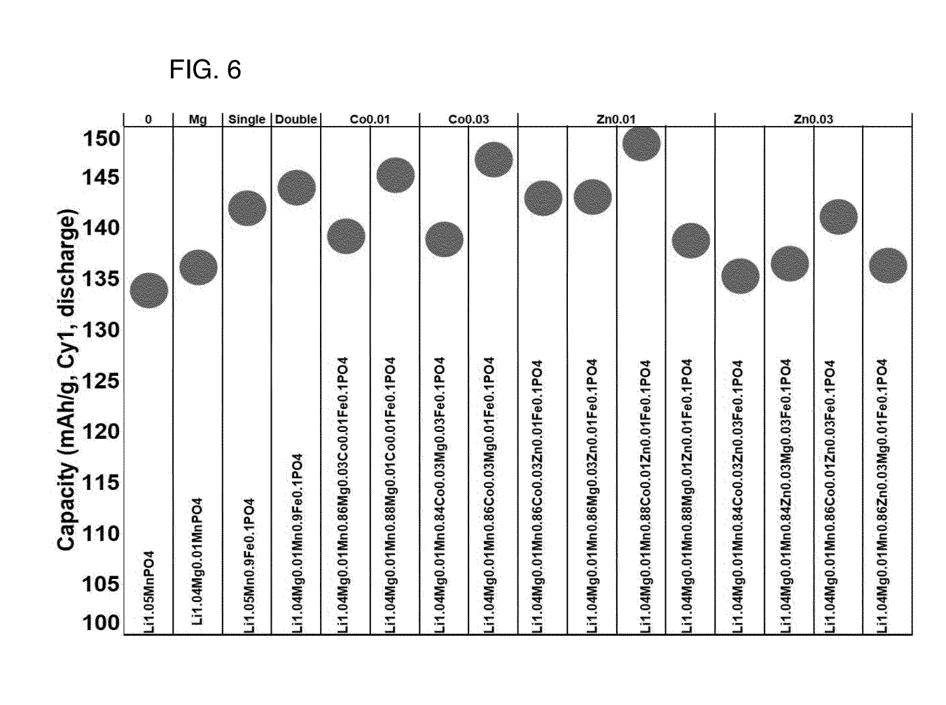

FIGS. 6, 7, and 8 illustrate electrochemical characterization of embodiments in which Mg is doped into the Li site and different elements are doped into the Mn site of an LMP active material. The materials in these figures can be represented by the formula:

Li_{1.05-x}MgₓMn_{0.9-y-z}M1_{y}M2_{z}Fe_{0.1}PO₄ (iv)

where 0.005≦x≦0.04, 0≦y≦0.05, and 0≦z≦0.05. In this embodiment, the samples of LMP active material can be Fe doping on the Mn site, and the further dopants M1 and M2 are chosen among Mg, Co, or Zn. The identity and the amount of one dopant appear on the top x-axis. The results of the electrochemical testing of following materials are show in FIGS. 6, 7, and 8:
Li_{1.05}MnPO₄ (no doping, excess lithium),
Li_{1.04}Mg_{0.01}MnPO₄ (Li doping only, Mg dopant),
Li_{1.05}Mn_{0.9}Fe_{0.1}PO₄ (Mn doping only, Fe dopant),
Li_{1.04} Mg_{0.01}Mn_{0.9}Fe_{0.1}PO₄ (Li doping, Mg dopant; Mn doped with Fe only),
Li_{1.04} Mg_{0.01}Mn_{0.86}Mg_{0.03}Co_{0.01}Fe_{0.1}PO₄,
Li_{1.04} Mg_{0.01}Mn_{0.88}Mg_{0.01} Co_{0.01}Fe_{0.1}PO₄,
Li_{1.04} Mg_{0.01}Mn_{0.84}Co_{0.03}Mg_{0.03}Fe_{0.1}PO₄,
Li_{1.04} Mg_{0.01}Mn_{0.86}Co_{0.03}Mg_{0.01}Fe_{0.1}PO₄,
Li_{1.04} Mg_{0.01}Mn_{0.86}Co_{0.03}Zn_{0.01}Fe_{0.1}PO₄,
Li_{1.04} Mg_{0.01}Mn_{0.86}Mg_{0.03}Zn_{0.01}Fe_{0.1}PO₄,
Li_{1.04} Mg_{0.01}Mn_{0.88}Co_{0.01}Zn_{0.01}Fe_{0.1}PO₄,
Li_{1.04} Mg_{0.01}Mn_{0.88}Mg_{0.01}Zn_{0.01}Fe_{0.1}PO₄,
Li_{1.04} Mg_{0.01}Mn_{0.84}CO_{0.03}Zn_{0.03}Fe_{0.1}PO₄,
Li_{1.04} Mg_{0.01}Mn_{0.84}Zn_{0.03}Mg_{0.03}Fe_{0.1}PO₄,
Li_{1.04} Mg_{0.01}Mn_{0.86}Co_{0.01}Zn_{0.03}Fe_{0.1}PO₄, and
Li_{1.04} Mg_{0.01}Mn_{0.86}Zn_{0.03}Mg_{0.01}Fe_{0.1}PO₄.

In FIGS. 6, 7, and 8, several control materials demonstrates the superiority of the inventive embodiments. The control material Li_{1.05}MnPO₄ has an excess of lithium but has no doping. The material Li_{1.04}Mg_{0.01}MnPO₄ has an excess of Li and Mg as a dopant on the Li site. The material Li_{1.05}Mn_{0.9}Fe_{0.1}PO₄ has an excess of Li and doping of Fe on the Mn site only. The material Li_{1.04} Mg_{0.01}Mn_{0.9}Fe_{0.1}PO₄ has an excess of Li and Mg as a dopant on the Li site and well as doping of Fe on the Mn site.

FIG. 6 illustrates significant first cycle capacity improvement over undoped and singly doped materials, even though such materials also have an excess of lithium. For example, the material Li_{1.04} Mg_{0.01}Mn_{0.9}Fe_{0.1}PO₄ (labeled as “Double” on the upper x-axis) shows improvement of up to about 10% in first cycle capacity over the basic control material Li_{1.05}MnPO₄. Several other double or triple doped materials show even more improvement, such as Li_{1.04}Mg_{0.01}Mn_{0.88}Mg_{0.01} Co_{0.01}Fe_{0.1}PO₄, Li_{1.04}Mg_{0.01}Mn_{0.86}CO_{0.03}Mg_{0.01}Fe_{0.1}PO₄, and Li_{1.04}Mg_{0.01}Mn_{0.88}Co_{0.01}Zn_{0.01}Fe_{0.1}PO₄.

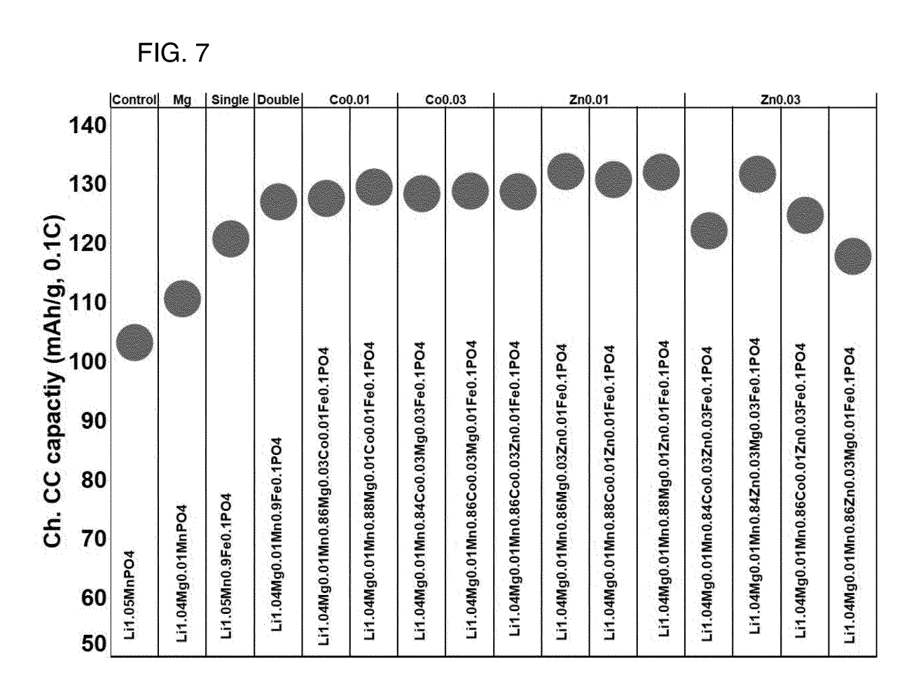

Similarly, FIG. 7 illustrates significant constant current charge rate capability improvement over undoped and singly doped materials, even though such materials also have an excess of lithium. For example, the material Li_{1.04} Mg_{0.01}Mn_{0.9}Fe_{0.1}PO₄ (labeled as “Double” on the upper x-axis) shows improvement of up to about 25% in constant current charge rate capability over the basic control material Li_{1.05}MnPO₄. FIG. 7 shows that many of the double or triple doped materials maintain or improve upon this 25% increase in charge rate capability.

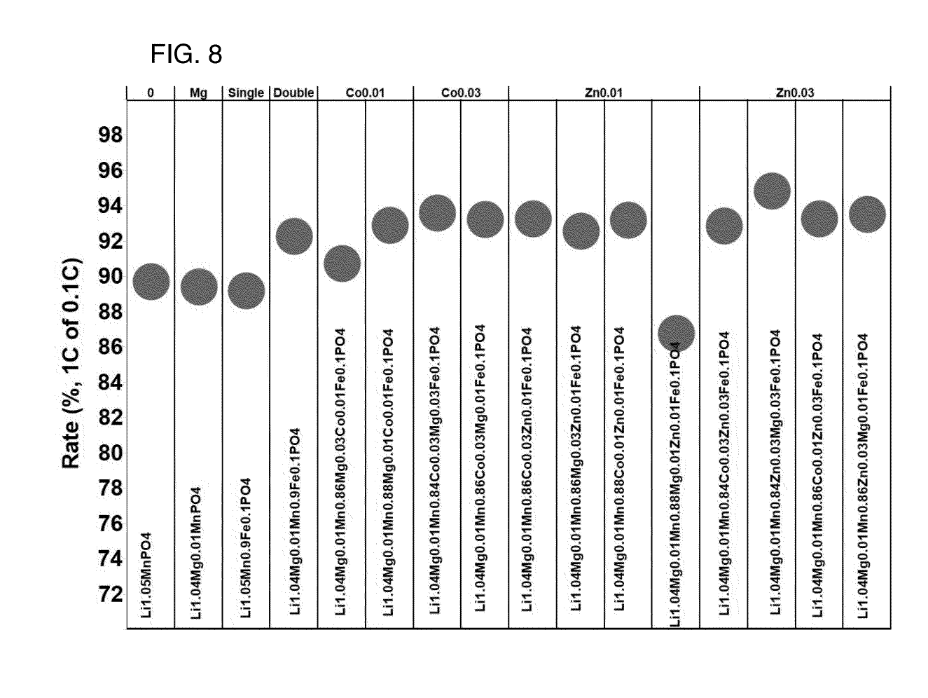

Still further, FIG. 8 illustrates significant discharge rate improvement over undoped and singly doped materials, even though such materials also have an excess of lithium. For example, the material Li_{1.04} Mg_{0.01}Mn_{0.9}Fe_{0.1}PO₄ (labeled as “Double” on the upper x-axis) shows improvement of over 3% in discharge rate over the basic control material Li_{1.05}MnPO₄. FIG. 8 shows that many of the double or triple doped materials improve upon this 3% increase in discharge rate.

The improvements generated by the compounds of the present invention are significant and unexpected in view of the prior art. For example, European Patent No. 2178137 discloses Mg doping of the Li site of a lithium phosphate material, but not in the presence of excess lithium. The ratio of Li plus the Mg dopant to P and to the other metals present in the lithium phosphate is fixed at 1. The compounds of European Patent No. 2178137 would not yield the performance improvements disclosed herein.

The same can be said for U.S. Pat. No. 7,060,238 and U.S. Patent Publication No. 2013/0140496 in that the ratio of Li to P is fixed at 1. Thus, these references do not disclose an excess of Li and in particular do not disclose the double doping of the Li site and the Mn site.

According to the embodiments disclosed herein, a combination of Mg doping on Li site and excess lithium (that is, (Li+Mg)/M1>1) shows electrochemical performance improvement.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. An electrode, comprising:
a material represented by Li₁₊ₓM1_{y}Mn_{z}PO₄ where 0.01≦x≦0.2, 0.01≦y≦0.1, and 0.95≦z≦1; and
wherein M1 is a dopant.

2. The electrode of claim 1 wherein M1 comprises an alkaline earth metal.

3. The electrode of claim 1 wherein M1 comprises Mg.

4. The electrode of claim 1 wherein z=1.

5. The electrode of claim 1 wherein the material comprises Li_{1.02}Mg_{0.03}MnPO₄.

6. An electrode, comprising:
a material represented by Li_{1.05-x}M1ₓMnPO₄ where 0.01≦x≦0.04 and M1 comprises an alkaline earth metal.

7. The electrode of claim 6 wherein M1 comprises Mg.

8. The electrode of claim 6 wherein the material comprises Li_{1.02}Mg_{0.03}MnPO₄.

9. An electrode, comprising:
a material represented by Li₁₊ₓMg_{y}Mn_{z}M1_{w}PO₄ where 0.01≦x≦0.2, 0≦y≦0.1, 0.85≦z≦1, and 0.01≦w≦0.2; and
wherein M1 is one or more dopants.

10. The electrode of claim 9 wherein M1 comprises a transition metal.

11. The electrode of claim 9 wherein M1 comprises Fe, Co, Zn, Mg, V, Ni, Nb, Cu, Cr, Ti or a combination thereof.

12. The electrode of claim 9 wherein M1 comprises three different elements selected from the group consisting of Fe, Co, Zn, Mg, V, Ni, Nb, Cu, Cr, and Ti.

13. The electrode of claim 9 wherein M1 comprises Fe and two elements selected from the group consisting of Mg, Co, and Zn.

14. An electrode, comprising:
a material represented by Li_{1.05-x}MgₓMn_{0.9-y-z}M1_{y}M2_{z}Fe_{0.1}PO₄ where 0.0051≦x≦0.04, 0≦y≦0.05, and 0≦z≦0.05; and
M1 and M2 each comprise a transition metal or alkaline earth metal.

15. The electrode of claim 14 wherein M1 and M2 each comprise a different transition metal or alkaline earth metal.

16. The electrode of claim 14 wherein M1 comprises Mg, Co, or Zn.

17. The electrode of claim 14 wherein M2 comprises Mg, Co, or Zn.

18. The electrode of claim 14 wherein M1 and M2 each comprise a metal selected from the group consisting of Mg, Co, or Zn.
